(19) United States
(12) Patent Application Publication
(10) Pub. No.: US 2019/0126490 A1
(43) Pub. Date: May 2, 2019

(54) COMMAND AND CONTROL INTERFACE FOR COLLABORATIVE ROBOTICS

(71) Applicant: CA, Inc., Islandia, NY (US)

(72) Inventor: Serge Mankovskii, Morgan Hill, CA (US)

(21) Appl. No.: 15/794,343

(22) Filed: Oct. 26, 2017

(51) Int. Cl. B25J 13/08; G06F 3/0484; B25J 13/00; B25J 19/02; G06F 3/0486; G06K 9/00

(52) U.S. Cl. CPC B25J 13/08; G06F 3/04845; G06K 9/00671; B25J 19/023; G06F 3/0486; B25J 13/006

(57) ABSTRACT

Aspects of the embodiments are directed to a real-time robot command and control interface. An aspect of the interface allows a user to select objects from an image of a scene and to reposition the objects within the scene. Another aspect of the interface can process the image data to determine one or more commands for instructing a robot to move the object to a desired location. The interface can use image and pattern recognition algorithms to determine the new location of the object and can use control algorithms to instruct the robot to move the object.

### FIELD

The present disclosure relates to command and control interfaces for collaborative robotics.

### BACKGROUND

Collaborative robots, or “cobots,” are robots that are designed to operate collaboratively with humans. Modern robotics is expanding to include environments in closer proximity to humans, allowing humans and robots to work together—collaboratively. Features of modern robotics that facilitate collaboration include increases in dexterity as well as decreases in formfactor and weight. Collaborative robots, because of their closer proximity to humans, benefit from a command and control system that allows the robots to work safely while still carrying out their assigned tasks.

### BRIEF DESCRIPTION OF THE DRAWINGS

FIG. 1 is a schematic diagram of a system in accordance with embodiments of the present disclosure.

FIG. 2 is a process flow diagram for creating an indication of the repositioning of an object in a captured image in accordance with embodiments of the present disclosure.

FIG. 3 is a process flow diagram for instructing a robot to move an object based on a repositioning of an image of the object in accordance with embodiments of the present disclosure.

FIG. 4 is a process flow diagram for instructing a robot to move an object based on a real-time dragging and dropping of an image of the object within a coordinate space in accordance with embodiments of the present disclosure.

FIGS. 5A-D are diagrams that illustrate an interface for indicating the repositioning of an object in accordance with embodiments of the present disclosure.

Figures may not be drawn to scale; like reference numbers denote like elements across the various drawings.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language, such as JAVA.®., SCALA.®., SMALLTALK.®., EIFFEL.®., JADE.®., EMERALD.®., C++, C#, VB.NET, PYTHON.®. or the like, conventional procedural programming languages, such as the “C” programming language, VISUAL BASIC.®., FORTRAN.®. 2003, Perl, COBOL 2002, PHP, ABAP.®., dynamic programming languages such as PYTHON.®., RUBY.®. and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Collaborative robotics suffer from difficulty of programming directives for actions expected from collaborative robots. The difficulty arises from broad variability of command and control interfaces, power that can be exerted on a foreign object by the robots, geometry of the robots and safety consideration for the robot, subject of robot action and the human controlling the robot. The problems are even greater if the desired action should be performed by multiple robots simultaneously or in succession. Aspects of the embodiments can overcome certain issues, including (P1) the difficulty of pointing out exact desired subject of action among other possible subjects, (P2) expressing future desired position of the subjects, and (P3) orchestrating beginning and end of collaborative move.

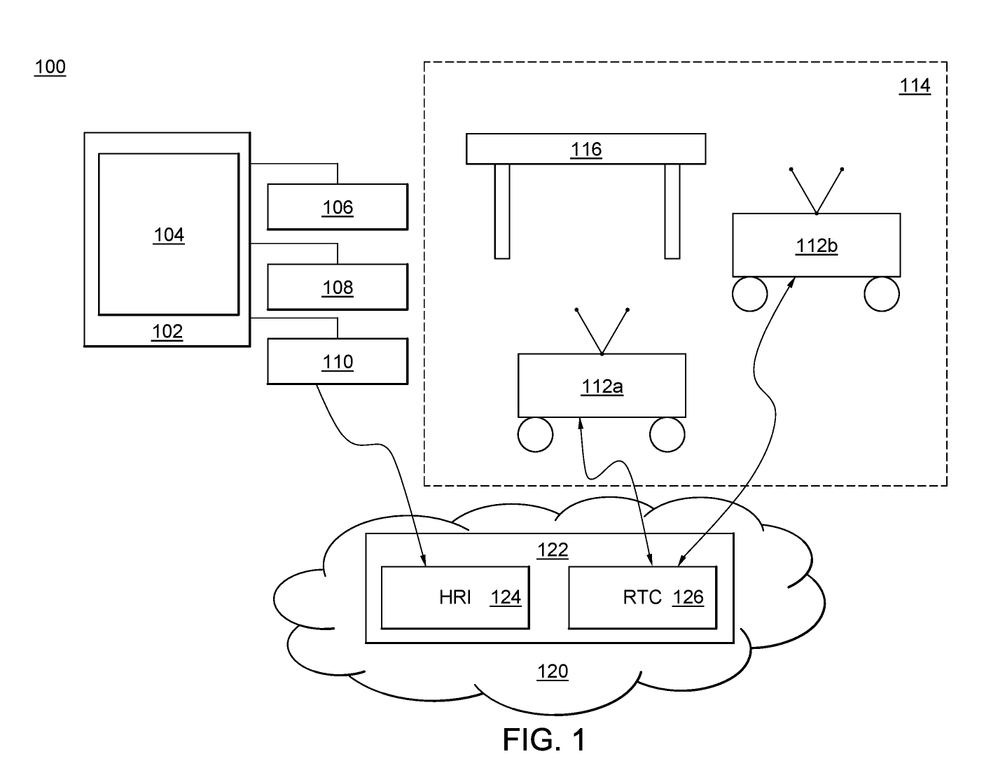

FIG. 1 is a schematic diagram of a system 100 in accordance with embodiments of the present disclosure. The system 100 includes of a user device 102. User device 102 can be a mobile computing device, such as a laptop, tablet computer, smartphone, desktop computer, etc. The user device 102 can include a touch screen 104. The touch screen 104 can display images captured by a camera 106. For example, the user device 102 can provide a user interface displayed on touch screen 104 that allows a user to identify objects of interest from an image of a region of interest, select and copy an image of an object from the image of the ROI, and store the image of the object as a file. The interface can make use of image recognition and image selection algorithms. The user device 102 can include an inertial measurement unit (IMU) 108, that can include a gyroscope, accelerometer, and/or other inertial measurement components. The user device 102 also includes a wireless interface 110 for communicating with a networked (or cloud-based) application programming interface (API) for real-time control of the robots.

In embodiments, the user device can make use of IMU 108 to allows the user to hold the user device 102 as a steering wheel. The user can rotate the device 102 clockwise or counter clockwise to steer direction of movement of the subject. The user can tilt the user device 102 forward or backward changes speed of the subject movement. The user can shift that user device 102 left or right and forward or backward to control the relative speed and/or alignment of the respective sides of the subject.

The user device 102 communicate with a network-based API 122. The API 120 can include distributed functionality, such as a human-robot-interface (HRI) 124 and a robot controller (RTC) 126. The HRI 124 and the RTC 126 can be distributed across a network-based cloud system 120.

The user device 102 can use the API 122 to control one or more robots 112a and 112b. The robots 112a-b can be located in a room 114 that includes one or more objects 116. The user can be in the room 114 to send real-time control information, or can be in a different room. The user can capture a photograph of the room 114 including the object 116 while in the room, but can process the image, reposition an image of the object, and transmit the image data to the API 122 across a network from a remote location.

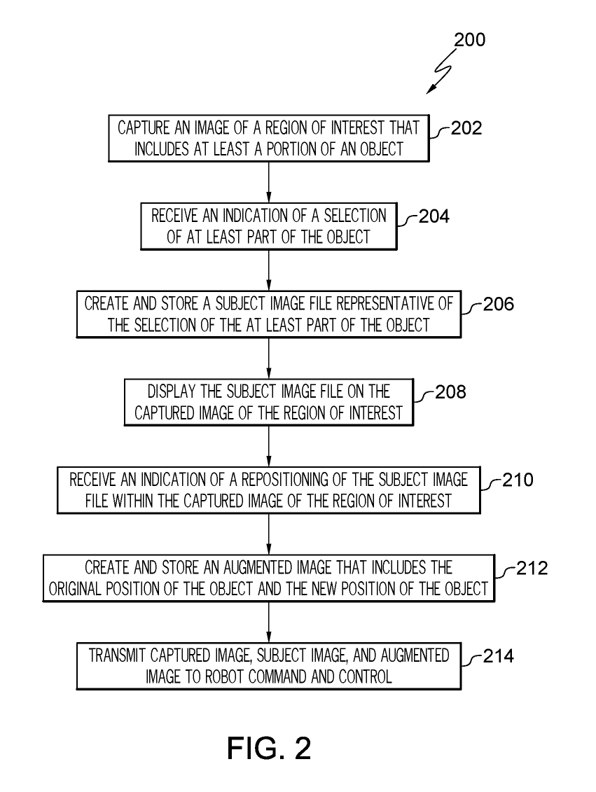

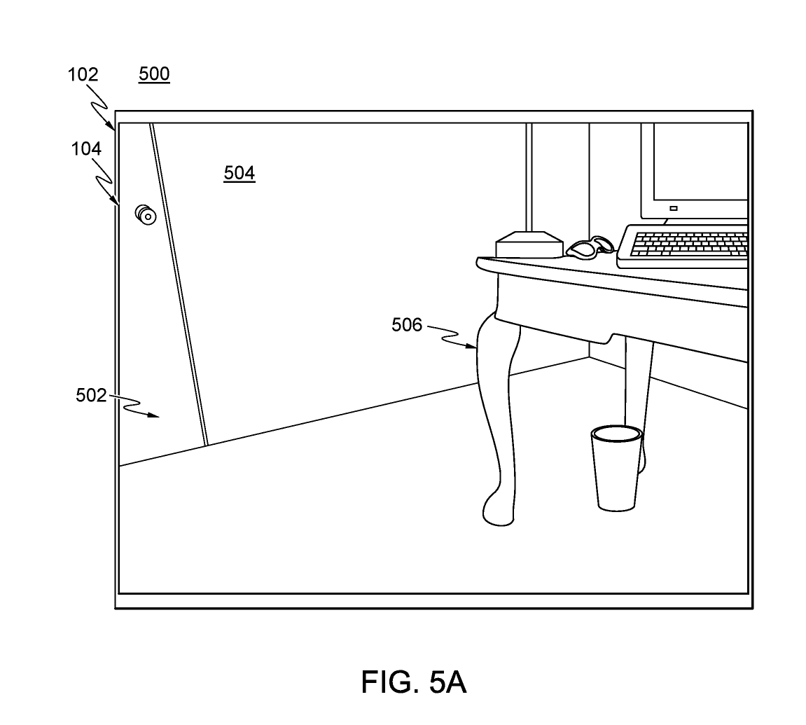

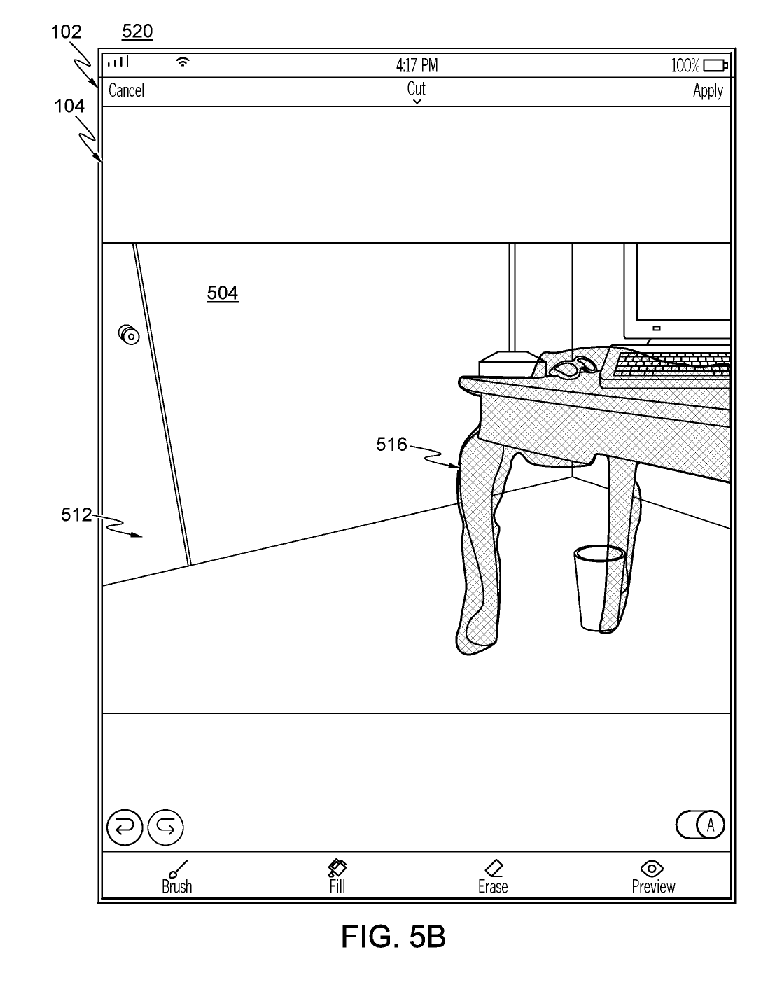

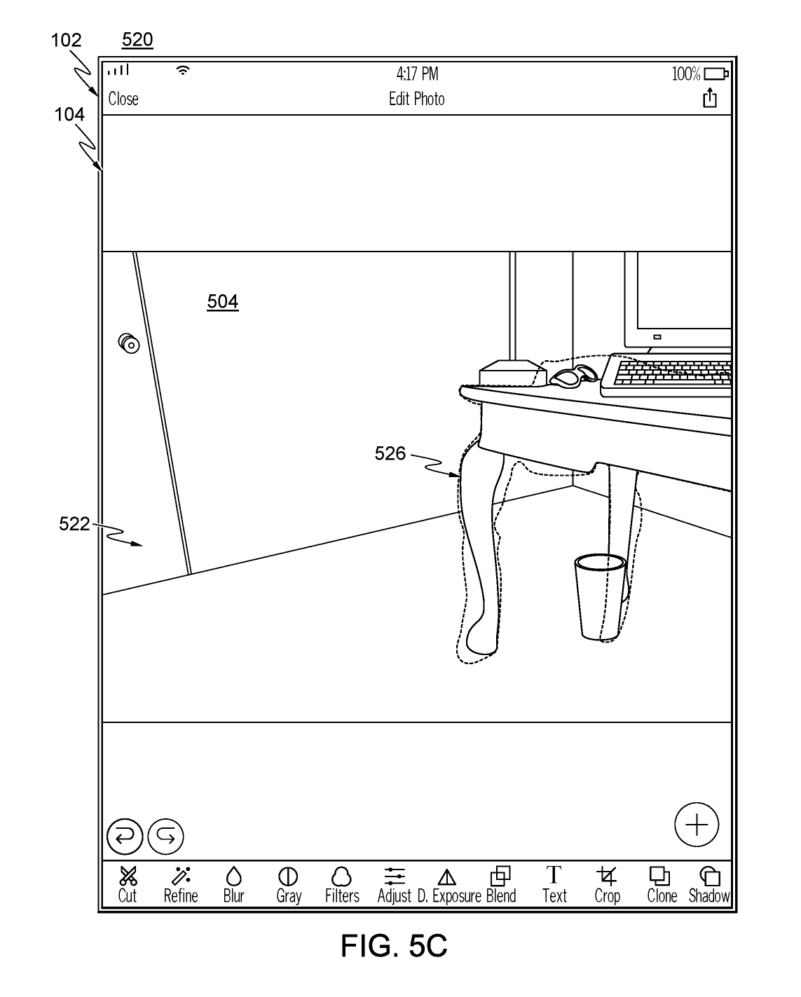

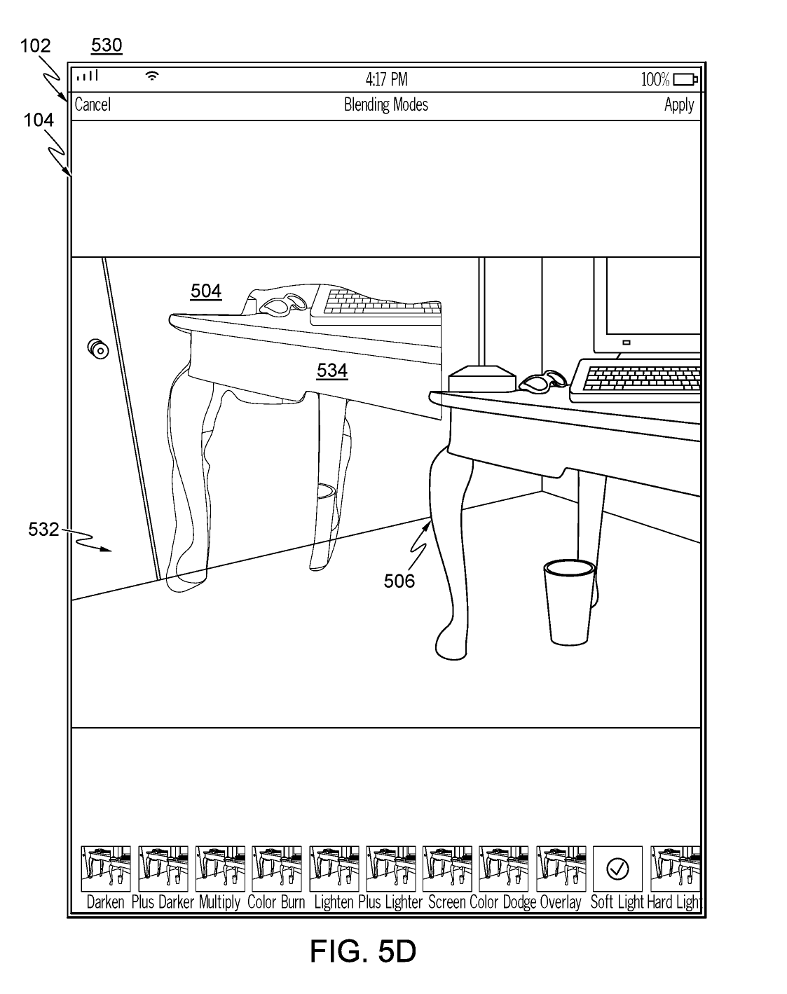

FIG. 2 is a process flow diagram 200 for creating an indication of the repositioning of an object in a captured image in accordance with embodiments of the present disclosure. A user can capture a picture of a scene, such as a room or other region of interest (ROI) containing an object to be moved (202). FIG. 5A illustrates a schematic diagram 500 of a user device 102 that includes a screen 104. FIG. 5A shows a captured image 502 of a room 504 that includes an object (desk 506). The image 502 is shown to appear in the display screen 104.

The user can open the image in an application interface for robot controls or an image processor that allows the user to select objects within the image. FIGS. 5B-D show the same image opened in a photo editor application. The user can highlight the object, which provides an indication of the selection of the object (204). FIG. 5B is a diagram 510 that shows the image 512 with the highlighted object 516. The user can select the object on the image by gliding a finger or mouse or stylus on the screen over object on the picture. The user can then create a cutout 526 of the object, which is shown in FIG. 5C. FIG. 5C is a diagram 520 of

By selecting an outline or cutout 526 of the object, the user makes a copy or clone of the subject (206). The user can store the copy of the object as a separate file. The copy can be displayed onto the image (208). The copy of the image 534 is shown on FIG. 5D. FIG. 5D is a diagram 530 that shows the image 532 overlaid with a copy of the object 534. As shown in FIG. 5D, the copy of the object 534 is moved towards the picture of the wall 504.

The user can move the copy of the image 534 to a new position on the image. Receive an indication of a repositioning of the subject image file within the captured image of the region of interest (210). The interface can create and store an augmented image that includes the original position of the object and the new position of the object (212). The interface can transmit captured image, subject image, and augmented image to robot command and control across a network (214).

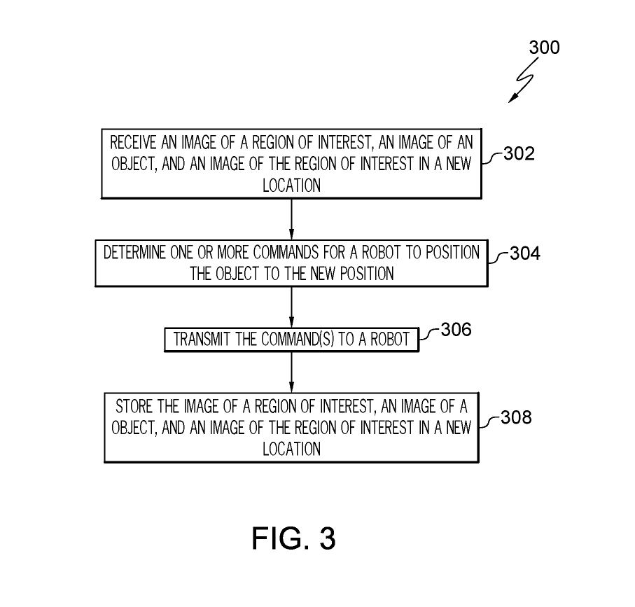

FIG. 3 is a process flow diagram 300 for instructing a robot to move an object based on a repositioning of an image of the object in accordance with embodiments of the present disclosure. The robot command and control (CandC) API can receive an image of a region of interest, an image of an object, and an image of the region of interest in a new location (302). The CandC API can determine one or more commands for a robot to position the object to the new position (304). The CandC API can transmit the command(s) to a robot (306). The CandC API can store the image of a region of interest, an image of an object, and an image of the region of interest in a new location (308).

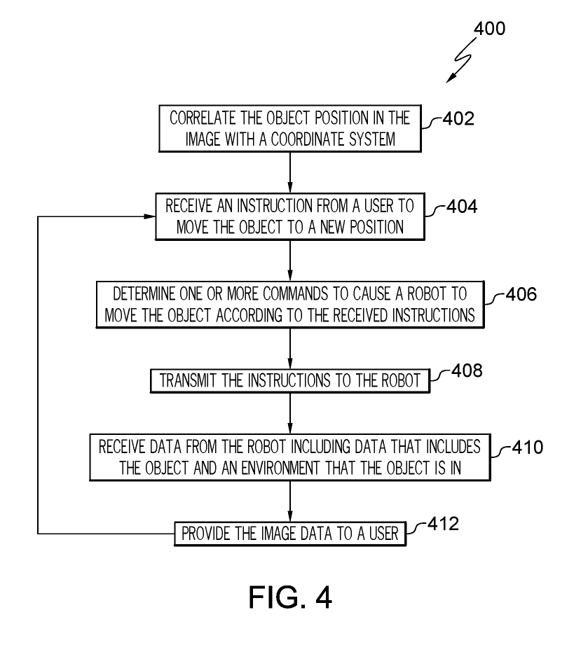

FIG. 4 is a process flow diagram 400 for instructing a robot to move an object based on a real-time dragging and dropping of an image of the object within a coordinate space in accordance with embodiments of the present disclosure. A command and control (CandC) system can include a CandC API can correlate the object position in the image with a coordinate system (402). The CandC API can receive an instruction from a user to move the object to a new position (404). The CandC API can determine one or more commands to cause a robot to move the object according to the received instructions (406). The CandC API can transmit the instructions to the robot (408).

In embodiments, CandC system can receive data from the robot (410). The image data can include an image of the object, an image of the environment, location information about the robot and/or the object, telemetry information, movement information, and other information that allows the CandC system to monitor the process of the robot and to provide updates of the robot's progress to a user.

The CandC system can provide some or all of the data to the user (412). In some embodiments, the CandC (e.g., the RTC) can notify the user about progress of the move by providing a visual indication of the robot's movements and/or the movement of the object. For example, the changing a position of the cutout of the object on the background image by sending successive updates of the image to the user device to be displayed on the display.

The CandC system can receive an additional instruction from the user to reposition the object and/or the robot (404), which restarts the cycle.

In embodiments, as a robots moves and object into a new scene (e.g., a different room or into a field of view of a different imaging device), the process of capturing of the image of the environment repeats from the beginning. That is, an image of the scene, and the object in the scene can be displayed. A user or controller can select an image of the object and move the image to a desired location in the image of the new scene. The image data can be sent to a CandC system to process the image data to control the robot.

In embodiments, more than one robot can be controlled by the CandC system to move an object or to move multiple objects selected in the scene. A single robot can also use multiple appendages to move multiple objects in a single CandC session.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure, with various modifications contemplated.

While the present disclosure has been described in connection with preferred embodiments, it will be understood by those of ordinary skill in the art that other variations and modifications of the preferred embodiments described above may be made without departing from the scope of the disclosure. Other embodiments will be apparent to those of ordinary skill in the art from a consideration of the specification or practice of the disclosure disclosed herein. It will also be understood by those of ordinary skill in the art that the scope of the disclosure is not limited to use in a server diagnostic context, but rather that embodiments of the disclosure may be used in any transaction having a need to monitor information of any type. The specification and the described examples are considered as exemplary only, with the true scope and spirit of the disclosure indicated by the following claims.

What is claimed is:

1. A computer-implemented method for providing an interface for controlling a robot, the method comprising:
receiving a captured image of a scene from a camera on a user device, the scene comprising an object;
receiving an indication of an object selection;
creating an image file representative of the object;
providing the image file representative of the object for display over the image of the scene;
receiving an indication of a repositioning of the object;
storing an augmented image of the scene, the augmented image comprising an image of the object positioned at a new position; and
transmitting the augmented image of the scene, the image file representative of the object, and the captured image of the scene to a robot command and control interface across a network connection.

2. The computer-implemented method of claim 1, wherein receiving an indication of object selection comprises:
receiving an outline around an object; and
determining an object that is being selected based on an image recognition of the outlined object.

3. The computer-implemented method of claim 1, wherein receiving an indication of a repositioning of the object comprises:
receiving an indication that the user has changed a position of the image file representative of the object on the captured image of the scene

4. The computer-implemented method of claim 3, wherein receiving an indication that a user has changed a position of the image file of the object on the captured image comprises receiving an inertial measurement signal that indicates a desired shifting and/or rotation of the image file of the object.

5. A non-transitory computer readable medium having program instructions stored therein, wherein the program instructions are executable by a computer system to perform operations comprising:
receiving a captured image of a scene from a camera on a user device, the scene comprising an object;
receiving an indication of an object selection;
creating an image file representative of the object;
providing the image file representative of the object over the image of the scene for display;
receiving an indication of a repositioning of the object;
storing an augmented image of the scene, the augmented image comprising an image of the object positioned at a new position; and
transmitting the augmented image of the scene, the image file representative of the object, and the captured image of the scene to a robot command and control interface across a network connection.

6. The non-transitory computer readable medium of claim 5, the operations further comprising:
receiving an outline around an object; and
determining an object that is being selected based on an image recognition of the outlined object.

7. The non-transitory computer readable medium of claim 5, the operations further comprising:
receiving an indication that the use has changed a position of the image file of the object on the captured image.

8. A non-transitory computer readable medium of claim 5, the operations further comprising receiving an inertial measurement signal that indicates a desired shifting and/or rotation of the image file of the object.

9. A computer-implemented method comprising:
receiving, from a user device across a network connection, a captured image of a scene comprising an object, an image file representative of the object in the scene, and an augmented image file comprising an indication of a new position of the object in the scene;
determining one or more commands for a robot to move the object to a position identified in the augmented image file; and
transmitting the one or more commands to the robot.

10. The method of claim 9, further comprising:
receiving one or more images of the object in a scene captured by the robot;
providing one or more images of the object in the scene captured by the robot in response to the robot moving the object;
receiving an updated augmented image file indicating a new position of the object in the scene;
determining one or more updated commands to reposition the object according to the updated augmented image file; and
transmitting the updated commands to the robot.

11. The method of claim 9, further comprising correlating the position of the object in the augmented image file with a coordinate system.

12. The method of claim 11, further comprising:
receiving an inertial measurement signal from the user, the inertial measurement signal comprising one or more of an indication to rotate, shift, or otherwise move the object to a new location;
using the coordinate system and the inertial measurement signal to determine one or more commands for the robot to reposition the object; and
transmitting the one or more commands to the robot.

13. The method of claim 9, further comprising:
receiving, from the robot, update information about progress of the robot in moving the object to the identified position; and
transmitting an indication of the update information to the user device across the network connection.

14. The method of claim 13, wherein the update information comprises image data captured by the robot, the image data comprising imagery of the object.

15. The method of claim 13, wherein transmitting an indication of the update information to the user device comprises:
determining a position of the object based on the update information;
identifying a stored image representative of the scene;
determining a location in the stored image representative of the scene corresponding to the position of the object;
providing the image file representative of the scene to the user for display; and
providing the image file representative of the object in the scene on the image representative of the scene in the determined location to the user for display.

16. The method of claim 15, further comprising:
receiving a new indication from the user device to reposition the object; and
determining one or more new commands for the robot to reposition the object based, at least in part, on the new indication and the update information; and
transmitting the one or more new commands to the robot.

17. The method of claim 16, wherein the user provides the new indication iteratively for a duration of operation of the robot.

18. A non-transitory computer readable medium having program instructions stored therein, wherein the program instructions are executable by a computer system to perform operations comprising:
receiving, from a user device across a network connection, a captured image of a scene comprising an object; an image file representative of the object in the scene, and an augmented image file comprising an indication of a new position of the object in the scene;
determining one or more commands for a robot to move the object to the position identified in the augmented image file; and
transmitting the one or more commands to the robot.

19. The non-transitory computer readable medium of claim 18, further comprising program instructions executable by a computer to perform operations comprising:
providing one or more images of the object in the scene captured by the robot as the robot moves the object;
receiving an updated augmented image file indicating a new position of the object in the scene;
determining one or more updated commands to reposition the object according to the updated augmented image file; and
transmitting the updated commands to the robot.

20. The non-transitory computer readable medium of claim 18, further comprising program instructions executable by a computer to perform operations comprising correlating the position of the object in the augmented image file with a coordinate system.

21. The non-transitory computer readable medium of claim 20, further comprising program instructions executable by a computer to perform operations comprising:
receiving an inertial measurement signal from the user, the inertial measurement signal comprising one or more of an indication to rotate, shift, or otherwise move the object to a new location;
determining one or more commands for the robot to reposition the object based, at least in part, the coordinate system and the inertial measurement signal; and
transmitting the one or more commands to the robot.

22. The non-transitory computer readable medium of claim 19, wherein transmitting an indication of the update information to the user device comprises:
determining a position of the object based on the update information;
identifying a stored image representative of the scene;
determining a location in the stored image representative of the scene corresponding to the position of the object;
displaying the image file representative of the scene to the user; and
displaying the image file representative of the object in the scene on the image representative of the scene in the determined location.

23. The non-transitory computer readable medium of claim 22, further comprising program instructions executable by a computer to perform operations comprising:
receiving a new indication from the user device to reposition the object; and
determining one or more new commands for the robot to reposition the object based, at least in part, on the new indication and the update information; and
transmitting the one or more new commands to the robot.
